(19) United States
(12) Patent Application Publication
(10) Pub. No.: US 2022/0373984 A1
(43) Pub. Date: Nov. 24, 2022

(54) HYBRID PHOTOVOLTAIC POWER PREDICTION METHOD AND SYSTEM BASED ON MULTI-SOURCE DATA FUSION

(71) Applicant: Shandong University, Jinan (CN)

(72) Inventors: Ming Yang, Jinan (CN); Yixiao Yu, Jinan (CN); Zhiyuan Si, Jinan (CN); Menglin Li, Jinan (CN); Peng Li, Jinan (CN)

(73) Assignee: Shandong University, Jinan (CN)

(21) Appl. No.: 17/663,757

(22) Filed: May 17, 2022

(30) Foreign Application Priority Data
May 19, 2021 (CN) 202110545719.3

(51) Int. Cl. G05B 19/042

(52) U.S. Cl. CPC G05B 19/042; G05B 2219/2639

(57) ABSTRACT

Disclosed in the present disclosure are a hybrid photovoltaic power prediction method and system based on multi-resource data fusion. The method includes: acquiring historical power sequence data and external meteorological data on a day to be predicted; inputting the data into a trained convolutional neural network prediction sub-model, long short-term memory network prediction sub-model and extreme gradient boosting tree prediction sub-model to predict photovoltaic power; classifying weather types according to a cloud cover on the day to be predicted, and determining prediction weights of the prediction sub-models; and fusing prediction results of the prediction sub-models based on the weights to obtain a final the prediction result of the photovoltaic power. The present disclosure integrates data of various different architectures, fully analyzes features of historical power data, meteorological data and satellite image data, and then fuses the data into unified data which is better and richer than single data.

### CROSS REFERENCE TO RELATED APPLICATION

The present application claims the priority of Chinese Patent Application No. 202110545719.3, filed with the China National Intellectual Property Administration (CNIPA) on May 19, 2021, which is incorporated herein by reference in its entirety.

### TECHNICAL FIELD

The present disclosure relates to the technical field of hybrid photovoltaic power prediction, and in particular to a hybrid photovoltaic power prediction method and system based on multi-resource data fusion.

### BACKGROUND ART

This section is merely intended to provide background information related to the present disclosure, and does not necessarily constitute the prior art.

With increasingly intensified contradiction between global warming and energy crisis, sustainable clean energy has developed rapidly in the past few years. Solar energy is inexhaustible and considered to be the most popular alternative to traditional energy. Therefore, the proportion of grid connection of photovoltaic power generation has been increasing in recent years. According to statistics, the total photovoltaic installed capacity has exceeded 400 GW. However, such features of solar energy as intermittence and fluctuation have brought great danger to a power system, greatly hindering the large-scale deployment of photovoltaic power stations. To ensure the safety and stability of the power system, photovoltaic power prediction methods and systems have gradually become an indispensable part of the power system. Accurate photovoltaic power prediction can facilitate the implementation of a demand response solution and improve power quality.

According to the time scale, the photovoltaic power prediction can be divided into short-term prediction, ultra-short-term prediction, and minute-level prediction. The short-term prediction is required to predict an output power of a photovoltaic power station from 0:00 of the next day to the next 72 hours, with a time resolution of 15 minutes. The ultra-short-term prediction is required to predict the output power of the photovoltaic power station from the next 15 minutes to 4 hours, with a time resolution of 15 minutes. The minute-level prediction is required to predict the output power of the photovoltaic power station on a time scale of 0-2 hours and a time interval of not more than 5 minutes. The ultra-short-term prediction of photovoltaic power needs to provide photovoltaic power data within the next 4 hours. Compared with the short-term prediction, ultra-short-term prediction has shorter period and closer to the prediction time, which can be used as the basis for power real-time dispatch. Therefore, the ultra-short-term prediction has higher requirements on the prediction accuracy, in particular on the tracking and predicting capability of rapid power fluctuations in non-sunny weather conditions.

At present, the ultra-short-term prediction method of photovoltaic power can be mainly divided into three categories: the statistical method, the physical method, and the cloud image-based method. The statistical method mainly includes time series analysis and autoregressive analysis. The methods such as the artificial neural network and the support vector machine popular in recent years can also be classified into the category of the statistical method. The physical method mainly seeks and establishes a correlation between each meteorological factor and the photovoltaic power based on the numerical weather prediction (NWP) data. Cloud images contain a lot of information such as motion states and distribution of clouds, so that the cloud images-based methods for photovoltaic prediction by using the cloud image as auxiliary information are emerging in recent years. However, under the influence of changes in weather conditions, ultra-short-term fluctuation characteristics of irradiance and photovoltaic power are diversified, and each prediction algorithm also has its limitations. Therefore, it is difficult to find an algorithm theory applicable to all weather conditions at present.

### SUMMARY

To solve the above problems, the present disclosure provides a hybrid photovoltaic power prediction method and system based on multi-resource data fusion, capable of implementing ultra-short-term prediction of photovoltaic power by fully fusing features of historical power data, meteorological data, and satellite image data.

In some implementations, the following technical solution is adopted:

A hybrid photovoltaic power prediction method based on multi-resource data fusion includes:

acquiring historical power sequence data and external meteorological data on a day to be predicted;

inputting the data into a trained convolutional neural network prediction sub-model, long short-term memory network prediction sub-model, and extreme gradient boosting tree prediction sub-model to predict photovoltaic power;

classifying weather types according to a cloud cover on the day to be predicted, and determining prediction weights of the prediction sub-models; and

fusing prediction results of the prediction sub-models based on the weights to obtain a final prediction result of the photovoltaic power.

In some other implementations, the following technical solution is adopted:

A hybrid photovoltaic power prediction system based on multi-resource data fusion includes:

a data acquisition module configured to acquire historical power sequence data and external meteorological data on a day to be predicted;

a power prediction module configured to input the data into a trained convolutional neural network prediction sub-model, long short-term memory network prediction sub-model, and extreme gradient boosting tree prediction sub-model to predict photovoltaic power;

a prediction weight module configured to classify weather types according to a cloud cover on the day to be predicted, and determine prediction weights of the prediction sub-models; and

a data fusion module configured to fuse prediction results of the prediction sub-models based on the weights to obtain a final prediction result of the photovoltaic power.

In some other implementations, the following technical solution is adopted:

A terminal device includes a processor and a memory, where the processor is configured to execute an instruction, the memory is configured to store a plurality of instructions, and the instructions are loaded by the processor to perform the hybrid photovoltaic power prediction method based on multi-source data fusion.

In some other implementations, the following technical solution is adopted:

A computer-readable storage medium stores a plurality of instructions, where the instructions are loaded by a processor of a terminal device to perform the hybrid photovoltaic power prediction method based on multi-source data fusion.

Compared with the prior art, the present disclosure has the following beneficial effects:

1. the present disclosure integrates data of different architectures, fully analyzes the features of historical power data, meteorological data, and satellite image data, and then fuses the data into unified data which is better and richer than single data;

2. the present disclosure selects proper sub-models according to features of different data to avoid the influence on prediction effect due to improper model selection, and considers the influence caused by various weather conditions to allow the present disclosure to have a wider application range; and

3. the present disclosure optimally combines the information contained in multiple single models based on maximum information utilization, considers the advantages of the different models, and can significantly improve the accuracy of photovoltaic power prediction compared with a single model prediction method.

The other features and the advantages of additional aspects of the present disclosure will be partially provided in the following description, and partially become obvious from the following description, or be understood through the practice of the present disclosure.

### BRIEF DESCRIPTION OF THE DRAWINGS

FIG. 1 is a flowchart of a hybrid photovoltaic power prediction method based on multi-source data fusion in the embodiments of the present disclosure;

FIG. 2 is a structural flowchart of a convolutional neural network sub-model in the embodiments of the present disclosure;

FIG. 3 is a structural flowchart of a long short-term memory network sub-model in the embodiments of the present disclosure;

FIG. 4 is a structural flowchart of an extreme gradient boosting tree sub-model in the embodiments of the present disclosure;

FIG. 5 is a graph of a photovoltaic power prediction result of each sub-model in the embodiments of the present disclosure;

FIG. 6 is a graph of a photovoltaic power prediction result of a combined model in the embodiments of the present disclosure; and

FIG. 7 is a graph of the comparison of prediction error results of different models in the embodiments of the present disclosure.

### DETAILED DESCRIPTION OF THE EMBODIMENTS

It should be noted that the following detailed descriptions are exemplary and are intended to provide further descriptions of the present disclosure. Unless specified otherwise, all technical and scientific terms used in the present disclosure have the same meanings usually understood by a person of ordinary skill in the art to which the present disclosure pertains.

It should be noted that the terms used herein are merely used for describing the specific implementations, but are not intended to limit the exemplary implementations of the present disclosure. As used herein, the singular forms are intended to include the plural forms as well, unless the context clearly indicates otherwise, and also, it should be understood that when the terms “include” and/or “comprise” are used in this specification, they indicate that there are features, steps, operations, devices, elements, and/or combinations thereof.

The embodiments in the present disclosure and the features in the embodiments can be combined with each other in a non-conflicting situation.

### Embodiment I

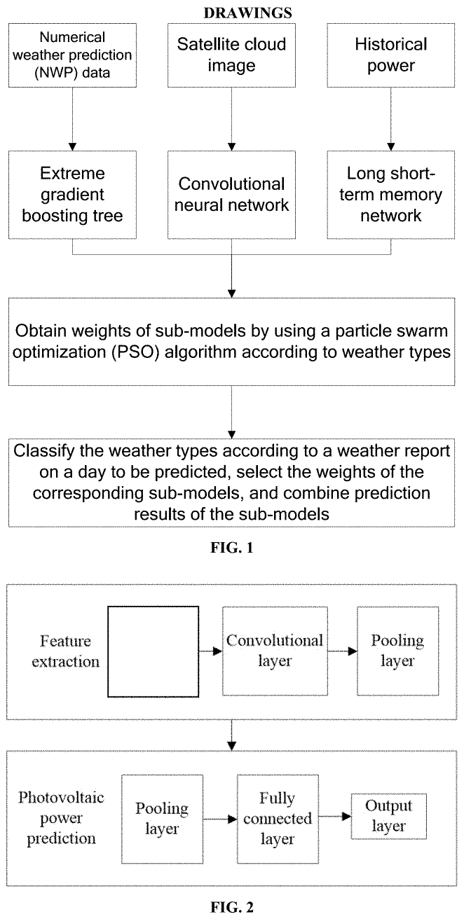

An embodiment of the present disclosure provides a hybrid photovoltaic power prediction method based on multi-resource data fusion. Concerning FIG. 1, the method includes the following steps.

(1) Acquire historical power sequence data and external meteorological data on a day to be predicted.

(2) Input the data into a trained convolutional neural network prediction sub-model, long short-term memory network prediction sub-model, and extreme gradient boosting tree prediction sub-model to predict photovoltaic power.

(3) Classify weather types according to a cloud cover on the day to be predicted, and determine prediction weights of the prediction sub-models.

(4) Fuse prediction results of the prediction sub-models based on the weights to obtain a final prediction result of the photovoltaic power.

In this embodiment, the features of multi-source heterogeneous data such as photovoltaic power data, meteorological data, and satellite image data are fully considered, and a proper deep learning method is selected to achieve optimal matching between each data source and each learning model. Moreover, samples are divided according to meteorological conditions, and the prediction results of the sub-models are fused by using a particle swarm optimization (PSO) method to construct a combined prediction model under different meteorological conditions, thereby improving the prediction accuracy. The prediction result provided by the method can provide a reference for the maintenance of photovoltaic power stations and the formulation of a power generation plan.

Specifically, the detailed implementation process of this embodiment is as follows:

First, relevant influence variables of model input should be selected. Factors that influence photovoltaic power fluctuations can be mainly divided into two categories according to data sources: one is to use endogenous data, namely an output power of a photovoltaic power station including current and/or lag time series; and the other is to use exogenous data, which is possibly from local measurements, satellite images, numerical weather prediction, etc. (contents include temperature, relative humidity, illuminance, cloud cover, wind velocity and direction, barometric pressure, etc.).

To explore the degree of influence of various factors on the photovoltaic power, a Pearson correlation coefficient is configured to analyze a correlation between each factor and the photovoltaic power. A formula for calculating the Pearson correlation coefficient is shown in (1):

$$r = \frac{\sum ID - \frac{\sum I \sum D}{N}}{\sqrt{( \sum {I}^{2} - \frac{{( \sum I )}^{2}}{N} ) ( \sum {D}^{2} - \frac{{( \sum D )}^{2}}{N} )}} \qquad ( 1 )$$

in the formula, I is the influencing variable; D is a measured value of the photovoltaic power; N is the number of test samples; and r is the correlation coefficient.

The endogenous data mainly includes a historical power sequence, where power at time t−1, power at time t−2, and power at time t−3 are selected, and t represents the current time. The exogenous data mainly includes meteorological factors, where temperature, humidity, wind velocity, rainfall, and cloud cover are selected. Table 1 provides results of the correlation between each factor and the photovoltaic power. It can be seen from the results in the table that exogenous factors such as temperature, humidity, and cloud cover and endogenous factors such as power at historical times have a high correlation with the photovoltaic power. Therefore, the variables such as temperature, humidity, cloud occlusion feature extracted from satellite images and historical power are selected as input variables of the model.

TABLE 1
Correlation coefficients between influence variables
and photovoltaic power

| Variable | Correlation coefficient |
|---|---|
| Temperature | 0.511 |
| Humidity | −0.336 |
| Wind velocity | 0.166 |
| Rainfall | −0.072 |
| Cloud cover | 0.669 |
| Powerₜ₋₁ | 0.762 |
| Powerₜ₋₂ | 0.551 |
| Powerₜ₋₃ | 0.341 |

Then, photovoltaic power prediction sub-models are constructed.

The photovoltaic output of a large power station is affected by many factors. Single prediction model is hard to take the various factors into account. Especially in extreme weather conditions, the single model is not sufficiently learned, which may lead to large prediction errors. A certain combination mode is selected to integrate the single models for prediction, information contained in the multiple single models is optimally combined, and respective advantages of the different models are considered so that the prediction accuracy can be significantly improved. According to different features of input data, the present disclosure separately constructs a convolutional neural network (CNN) prediction sub-model, a long short-term memory (LSTM) network prediction sub-model, and an extreme gradient boosting (XGBoost) tree prediction sub-model.

In machine learning, the convolutional neural network (CNN) is a deep feedforward artificial neural network, which is good at image processing and feature extraction, and this model can be configured to extract cloud shading factors in the satellite images. The long short-term memory (LSTM) network is a temporal recurrent neural network (RNN), which is suitable for processing and predicting important events having longer intervals and delays in time series and can be configured to mine change rules between historical power sequences. The extreme gradient boosting (XGBoost) tree belongs to a tree model, which can mine an internal relationship among different types of data, and this model has high calculation speed and high precision, and can be configured to establish the mapping relationship between the meteorological factors and the photovoltaic power.

In this embodiment, the three prediction sub-models are respectively trained by using the different types of data.

1) Convolutional Neural Network (CNN)

In machine learning, the convolutional neural network is a deep feedforward artificial neural network, which has been successfully applied to image recognition. At present, the convolutional neural network has become one of the research hotspots in many scientific fields, especially in the field of image feature extraction. This network avoids complex preprocessing on images and can directly input original images, and is thus widely applied. The convolutional neural network generally includes five layers: an input layer, convolutional layers, pooling layers, a fully connected layer, and an output layer. The convolutional layers and the pooling layers are key layers. A convolution operation can be expressed as (2):

y_{i,j,g}^{l}=f_{conv}((w^{l}_{g})^{T}x_{i,j}^{l}+b_{g}^{l}) (2)

where, w_{g}^{l} is a weight of a g-th convolution filter on a first layer, b_{g}^{l} is a bias of the first layer, an input region of a first-layer position (i, j) can be expressed as x^{l}_{i,j} and f_{conv} represents an activation function.

In the field of image recognition, sometimes the images are too large, and the number of training parameters needs to be reduced. Therefore, the pooling layers are regularly introduced between the convolutional layers. The purpose of pooling is to reduce a spatial size of the images. The pooling is completed separately in each depth dimension, so the depths of the images remain unchanged. The most common forms of pooling are max-pooling and mean-pooling. Final output of the pooling layers can be described as (3):

P_{i,j,g}^{l}=fₚₒₒₗ(y_{m,n,g}^{l}) (3)

where, y^{l}_{m, n, g} represents a result of the convolution operation, P^{l}_{i, j, g} represents a result of pooling, and f_{conv} represents a pooling operation. After the convolutional layers and the pooling layers, each node of the fully connected layer is connected to all nodes of a previous layer, and features extracted from the previous layer are synthesized. Due to fully connected properties of the fully connected layer, the fully connected layer generally has the most parameters. Finally, the output of the fully connected layer is final output of the convolutional neural network.

The movement of clouds is a major factor that influences photovoltaic power generation and causes strong fluctuations. The satellite images contain a lot of information about the shapes and features of the clouds. Therefore, the satellite images are important data resources for the accurate calculation of photovoltaic power in ultra-short-term prediction. A deep convolutional neural network can better understand the cloud images, which is difficult to express with an explicit formula. Therefore, the convolutional neural network sub-model combines the satellite images and the convolutional neural network, and the influence of cloud shading on the photovoltaic power can be better analyzed by using the advantages of the convolutional neural network. The structural flow of the convolutional neural network sub-model is shown in FIG. 2.

In this embodiment, the satellite images are first inputted into the convolutional neural network, the features are extracted by a series of convolutional layers and pooling layers, and the influence of the cloud shading factors on photovoltaic power generation is perceived. Finally, a predicted value of the photovoltaic power is obtained from the output layer.

2) Long Short-Term Memory (LSTM) Network

The long short-term memory network is a temporal recurrent neural network, which is suitable for processing and predicting the important events having longer intervals and delays in the time series. The long short-term memory network mainly differs from the recurrent neural network in that the long short-term memory network adds a processor “cell” to an algorithm for determining whether the information is useful. There are three gates in one unit, namely an input gate, a forget gate and an output gate. Herein, the input gate is configured to update new data, the forget gate is configured to determine which part of old information needs to be deleted, and the output gate is responsible for the output of the long short-term memory network. After a new message enters the long short-term memory network, whether the new message is useful is determined first according to rules, the only information that conforms to algorithm authentication is left, and information that does not conform to the algorithm authentication is forgotten by the forget gate. Finally, the processed data is outputted by the output gate.

The workflow of the long short-term memory network is as follows. First, input xₜ at time t is fused with output hₜ₋₁ at previous time t−1. Then, iₜ, fₜ and oₜ are obtained respectively through three activation functions, where iₜ indicates which new memories need to be updated, fₜ indicates how much the old information should be forgotten, and oₜ decides which part of a cell state will be derived. The retained old information and new information constitute a new cell state Cₜ. Finally, the cell state Cₜ is activated by tan h and multiplied by oₜ to determine output hₜ at time t. The workflow of the long short-term memory network can be expressed as (4)-(8):

iₜ=σ(Wₓᵢ·xₜ+Wₕᵢ·hₜ₋₁+bᵢ) (4)

fₜ=σ(w_{xf}·xₜ+W_{hf}·hₜ₋₁+b_{f}) (5)

Cₜ=fₜ·Cₜ₋₁+iₜ·tan h(W_{xc}·xₜ+W_{hc}·hₜ₋₁+b_{c}) (6)

oₜ=σ(Wₓₒ·xₜ+Wₕₒ·hₜ₋₁+bₒ) (7) and

hₜ=oₜ tan h(Cₜ) (8)

in the formula, a is the activation function, W is the weight of each threshold layer, xₜ is the input of a current time step t, and b is a bias of the corresponding gate.

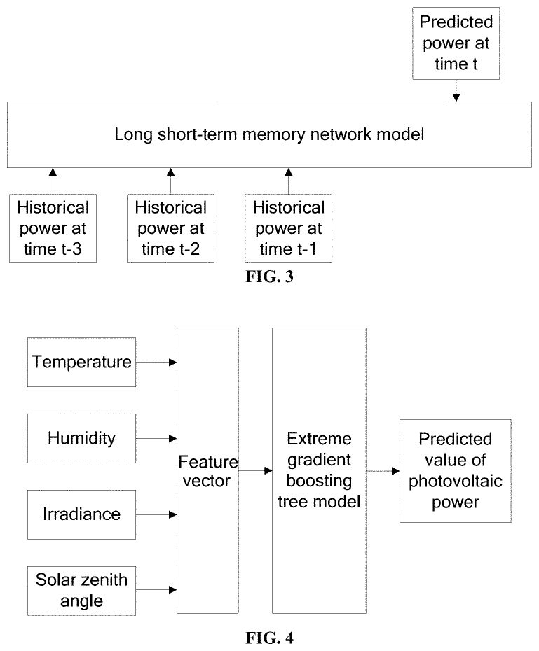

Time series prediction analysis uses temporal features of an event over a period of time in the past to predict features of that event over a period of time in the future. Historical sequences often contain specific trends of change. The ultra-short-term photovoltaic power prediction model based on time series is mainly configured to perform trend learning modeling on historical photovoltaic power data, and the purpose is to mine conversion features of historical photovoltaic power and infer power changes in the future. The long short-term memory network is a special recurrent neural network that solves problems of vanishing gradient and exploding gradient, and is particularly good at dealing with time series-related problems. Since there is a certain relationship between the photovoltaic power at adjacent moments, the long-short-term memory network sub-model will predict the future photovoltaic output by analyzing the existing laws of the historical photovoltaic power sequence. The structural flow of the long short-term memory network sub-model is shown in FIG. 3.

In this embodiment, the photovoltaic power at time t−1, the photovoltaic power at time t−2, and the photovoltaic power at time t−3 are inputted into the long short-term memory network, and a mapping relationship between said photovoltaic power and the photovoltaic power at time t is trained.

3) Extreme Gradient Boosting Tree (XGBoost)

The extreme gradient boosting tree has received extensive attention in recent years due to advantages such as high efficiency and high prediction accuracy. The extreme gradient boosting tree is a popularization method in a scalable machine learning system, belongs to a tree integration model, and uses a sum of predicted values of all trees as the predicted value of a sample. The extreme gradient boosting tree can be expressed as (9):

$${\hat{y}}_{i} = {\sum }_{k = 1}^{K} {f}_{k} ( {x}_{i} ) , {f}_{k} ∈ F \qquad ( 9 )$$

where, K is the number of trees, F is a set of all possible CART trees, and fₖ is a CART tree in F. To learn a function set used in the model, the extreme gradient boosting tree model minimizes the following regularization objectives:

$${Obj}^{( t )} = {\sum }_{i = 1}^{n} l ( {y}_{i} , {\hat{y}}_{i}^{( t - 1 )} + {f}_{t} ( {x}_{i} ) ) + Ω ( {f}_{t} ) + c \qquad ( 10 )$$

where ŷᵢ^{(t-1)} is prediction of a previous round t−1, and fₜ(x) is a new function of round t. An objective function includes three parts: the first part is a sum of differentiable convex loss functions 1, and describes a difference between the predicted value and a target value; the second part is a regularization term Ω(fₜ); and the last part is a constant term c.

The objective function is subjected to second-order Taylor expansion, then all constant terms are removed, and finally a partial derivative is calculated to obtain an optimal solution of the objective function. The optimal solution can be expressed as (11):

$${w}_{j}^{*} = - \frac{{G}_{j}}{{H}_{j} + λ} \qquad ( 11 )$$

where, wⱼ* represents the optimal solution, λ represents a regularized parameter, and Gⱼ and Hⱼ, represent intermediate variables.

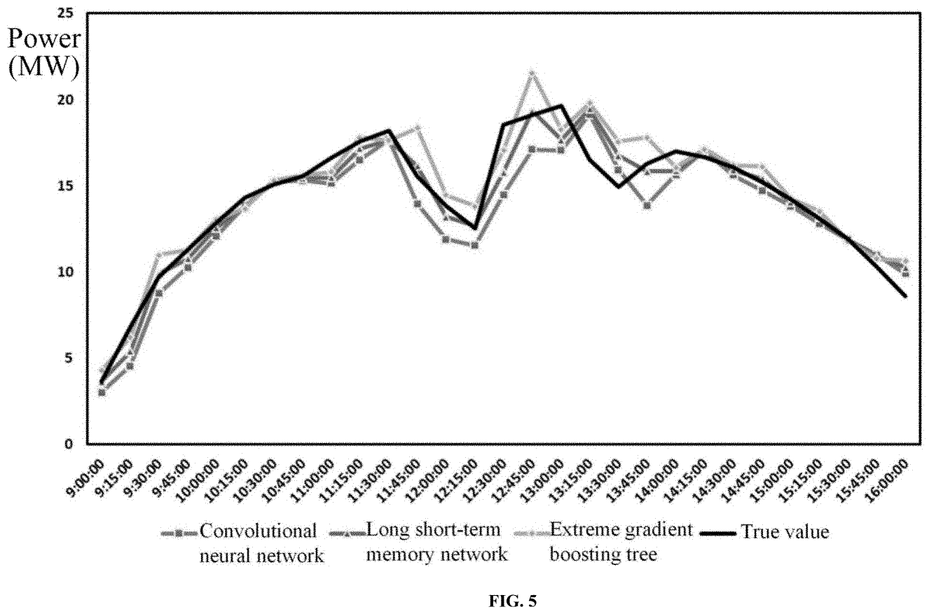

At present, numerical weather prediction has become the most accurate tool for predicting photovoltaic power or irradiance. For the ultra-short-term prediction, the photovoltaic power generation is mainly influenced by physical factors when photovoltaic equipment remains unchanged. Therefore, the factors having a strong correlation can be selected as features of prediction learning modeling. The Pearson correlation coefficient is a statistical magnitude that reflects the degree of similarity between two variables, and a value range thereof is [−1, 1]. When the value is negative, the two variables are in negative correlation; and when the value is positive, the two variables are in positive correlation. The larger the absolute value of the Pearson correlation coefficient, the larger the positive/negative correlation. Generally, the meteorological factors that influence photovoltaic power generation mainly include irradiance, wind velocity, wind direction, temperature, humidity, barometric pressure, etc. After the relevant screening, temperature, humidity, solar zenith angle, and irradiance as selected herein as the input. FIG. 4 shows the flow structure of the extreme gradient boosting tree sub-model.

In this embodiment, the influencing variables at time t are inputted into the extreme gradient boosting tree model, the output is the photovoltaic power at time t, and the mapping relationship between the meteorological data and the photovoltaic power is established.

In this embodiment, to integrate the advantages of deep learning technology and various prediction methods, the three prediction sub-models are fused to establish the combined model for predicting the photovoltaic power. Combining the satellite images with the convolutional neural network allows better extraction of cloud shading from sunlight. The mapping relationship between the meteorological factors and the photovoltaic power is established by the extreme gradient boosting tree to implement the prediction of photovoltaic power. Moreover, the long short-term memory network completes the ultra-short-term prediction of photovoltaic power by mining a correlation between each historical power sequence and predicted time power.

First, the sub-models are individually trained according to multi-source data. Then, the weather types are divided into sunny, cloudy and overcast situations according to the meteorological conditions, and sample sets are accordingly divided into the sunny set, the cloudy set, and the overcast set. For the different sample sets, the particle swarm optimization (PSO) algorithm is used to obtain optimal weights of the sub-models. Finally, the combined model under the different meteorological conditions is established.

Specifically, the theory of the PSO algorithm is as follows:

The PSO algorithm simulates a bird in a bird flock by designing a massless particle, the particle only has two attributes: velocity and position, the velocity represents a movement velocity, and the position represents a movement direction. Each particle separately searches for an optimal solution in a search space, denotes the optimal solution as a current individual extremum, shares the individual extremum with other particles in the whole particle swarm, finds an optimal individual extremum as a current global optimal solution of the whole particle swarm. Each particle in the particle swarm adjusts its velocity and position on the basis of based on the current individual extremum found by the particle and the current global optimal solution shared in the whole particle swarm. The particle swarm optimization algorithm has the advantages of being simple and easy to implement and having few parameters to be adjusted, and has been widely applied to application fields of function optimization, neural network parameter training, fuzzy system control and other genetic algorithms.

When predicting the photovoltaic power, first, the input variables (including NWP data, satellite images and historical power data) on the day to be predicted are respectively inputted into the three prediction sub-models for prediction, and the prediction results of the three sub-models can be obtained. The weather types are classified according to the cloud cover on the day to be predicted, if the cloud cover is less than or equal to 30% on the day, the day is determined to be sunny; if the cloud cover is greater than 30% and less than or equal to 70% on the day, the day is determined to be cloudy; and if the cloud cover is greater than 70% on the day, the day is determined to be overcast. Finally, the weight of the trained model under the corresponding weather type is selected according to the weather type on the day to be predicted, and the results of the three sub-models are combined to obtain a final prediction result.

In this embodiment, a mean absolute error (MAE) and a root mean square error (RMSE) are used to evaluate a performance of the method. Expression formulas (12) and (13) are as follows:

$$MAE = \frac{1}{N} {\sum }_{t = 1}^{N} \vert {y ( t )}^{*} - y ( t ) \vert and \qquad ( 12 )$$

$$RMSE = \sqrt{\frac{1}{N} {\sum }_{t = 1}^{N} {( {y ( t )}^{*} - y ( t ) )}^{2}} \qquad ( 13 )$$

where, y(t)* denotes the predicted value of the photovoltaic power at time t, y(t) denotes the actual value of the photovoltaic power at time t, and N is the number of samples in test sample set.

In this embodiment, the FY-2G satellite image is used, and the cloud image is updated every hour. NWP data is provided by the China Meteorological Administration. Moreover, the effectiveness of the method is verified by taking power generation data of a 30 MW photovoltaic power station in Ningxia as an example. The data is dated from January 2018 to November 2018, with a time resolution of 15 minutes. Datasets are divided into the training set and the test set. To ensure universality, the test set includes randomly selected days in each quarter, and the remaining days constitute the training set. Since the photovoltaic power generation is zero at night, only the data between 9:00 a.m. and 16:00 p.m. on the day is selected for the experiment.

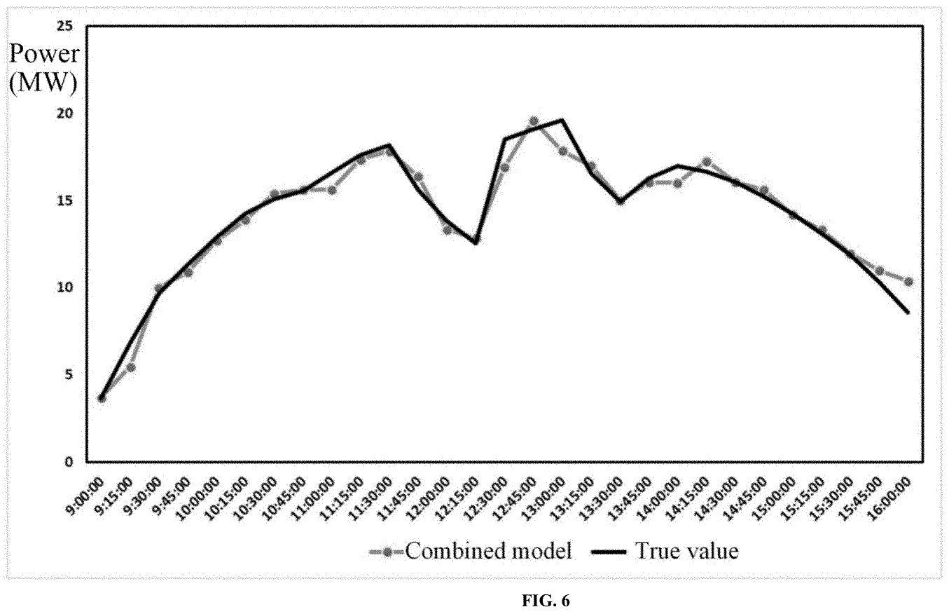

FIG. 5 shows the prediction results of photovoltaic power of the sub-models between 9:00 a.m. and 16:00 p.m. FIG. 6 shows the prediction result of photovoltaic power of the combined model. It can be seen from FIG. 5 that the results obtained by the different sub-models are different and fluctuate greatly. Both the long short-term memory network model and the extreme gradient boosting tree model can show excellent prediction performance, but there is still a large error between the predicted value and the true value. For the convolutional neural network model, in the cloudy situation, the satellite images can better reflect power fluctuations. However, since the temporal resolution of satellite images is 1 hour, it is difficult to perform minute-level fine prediction. Therefore, the models have different application environments. The long short-term memory network can extrapolate the time series by mining a serial correlation between historical power and historical power, which can effectively reflect the time changing trend of the power itself. The extreme gradient boosting tree model has a strong fitting capability and can mine a correlation between meteorology and the photovoltaic power in abundant data. The convolutional neural network is suitable for processing image data, and therefore can be configured to extract cloud cluster features in the satellite images and analyze the influence of cloud cluster shading on the photovoltaic power fluctuations. It can be seen from the two figures that after the combination of the different models, the prediction result of the combined model is closer to the true value, indicating that the combined model shows stronger universality and accuracy.

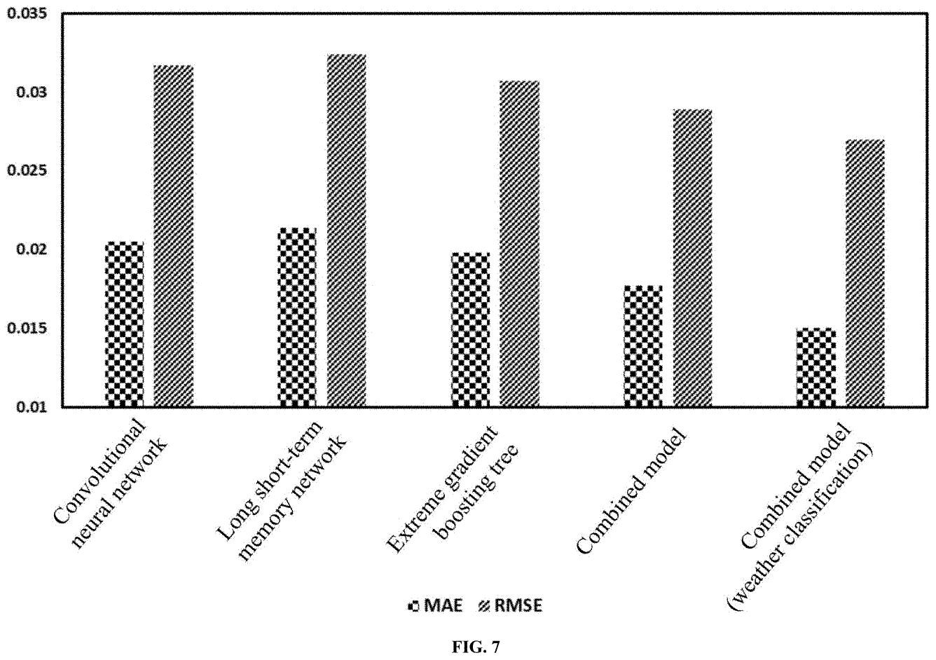

FIG. 7 shows the predicted error of the different models. First, errors of the prediction results of the sub-models are almost the same, but are all larger than that of the combined model, which also indicates that the sub-models show better prediction performance after the combination. Moreover, the combined model that considers weather classification can select corresponding weights according to the different weather types. It can also be seen in the figures that the error of the prediction result of the combined model that considers the weather types is smaller than that of the combined model that does not consider the weather types. This also verifies that after considering the division of weather types, the prediction accuracy of the model is further improved. Table 2 shows the comparison of the prediction errors for the sub-models and the combined model at different time scales. It can be seen that at any time scale, the accuracy of the combined model is higher than the prediction accuracy of the sub-models.

TABLE 2
Comparison of prediction errors for models at different time scales

| | | Mean | Root mean |
|---|---|---|---|
| | | absolute | square |
| | Time | error | error |
| Algorithm | scale | (MAE) | (RMSE) |
| Long short-term memory network | 15 min | 1.43 | 2.18 |
| model | 30 min | 1.92 | 2.67 |
| | 45 min | 2.35 | 3.24 |
| | 60 min | 2.78 | 3.96 |
| Convolutional neural network | 15 min | 1.49 | 2.26 |
| model | 30 min | 1.87 | 2.65 |
| | 45 min | 2.43 | 3.52 |
| | 60 min | 2.87 | 3.89 |
| Extreme gradient boosting | 15 min | 1.39 | 2.16 |
| tree model | 30 min | 1.83 | 2.61 |
| | 45 min | 2.31 | 3.19 |
| | 60 min | 2.76 | 3.93 |
| Combined model | 15 min | 1.28 | 2.03 |
| | 30 min | 1.78 | 2.45 |
| | 45 min | 2.03 | 2.76 |
| | 60 min | 2.66 | 3.78 |

### Embodiment II

An embodiment of the present disclosure provides a hybrid photovoltaic power prediction system based on multi-resource data fusion. The system includes a data acquisition module, a power prediction module, a prediction weight module, a data fusion module, and a data fusion module.

The data acquisition module is configured to acquire historical power sequence data and external meteorological data on the day to be predicted.

The power prediction module is configured to input the data into a trained convolutional neural network prediction sub-model, long short-term memory network prediction sub-model and extreme gradient boosting tree prediction sub-model to predict photovoltaic power.

The prediction weight module is configured to classify weather types according to the cloud cover on the day to be predicted, and determine the prediction weights of the prediction sub-models.

The data fusion module is configured to fuse prediction results of the prediction sub-models on the basis of the weights to obtain the final prediction result of the photovoltaic power.

It should be noted that the specific implementations of the modules have been described in detail in Embodiment I. Therefore, details are not described herein again.

### Embodiment III

An embodiment of the present disclosure provides a terminal device. The terminal device includes a processor and a memory, where the processor is configured to execute an instruction, the memory is configured to store a plurality of instructions, and the instructions are loaded by the processor to perform the hybrid photovoltaic power prediction method based on multi-source data fusion as described in Embodiment I.

Some other implementations provide a computer-readable storage medium. The computer-readable storage medium stores a plurality of instructions, where the instructions are loaded by a processor of a terminal device to perform the hybrid photovoltaic power prediction method based on multi-source data fusion as described in Embodiment I.

The above describes the specific implementations of the present disclosure with reference to the accompanying drawings, but is not intended to limit the protection scope of the present disclosure. A person skilled in the art should understand that any modifications or variations made by a person skilled in the art without creative efforts still fall within the protection scope of the present disclosure based on the technical solutions of the present disclosure.

What is claimed is:

1. A hybrid photovoltaic power prediction method based on multi-resource data fusion, comprising:
acquiring historical power sequence data and external meteorological data on a day to be predicted;
inputting the data into a trained convolutional neural network prediction sub-model, long short-term memory network prediction sub-model and extreme gradient boosting tree prediction sub-model to predict photovoltaic power;
classifying weather types according to a cloud cover on the day to be predicted, and determining prediction weights of the prediction sub-models; and
fusing prediction results of the prediction sub-models on the basis of the weights to obtain a final prediction result of the photovoltaic power.

2. The hybrid photovoltaic power prediction method based on multi-resource data fusion according to claim 1, wherein a correlation between each influence factor and the photovoltaic power is calculated by using a Pearson correlation coefficient, and the historical power sequence data as well as temperature, humidity and satellite image data are determined as input data of a prediction model.

3. The hybrid photovoltaic power prediction method based on multi-resource data fusion according to claim 1, wherein the convolutional neural network prediction sub-model is trained by using the satellite image data as input data, so as to determine the influence of cloud shading factors on photovoltaic power generation.

4. The hybrid photovoltaic power prediction method based on multi-resource data fusion according to claim 1, wherein the long short-term memory network prediction sub-model is trained by using the historical power sequence data as the input data, so as to train a mapping relationship between the historical power sequence data and the photovoltaic power at time t.

5. The hybrid photovoltaic power prediction method based on multi-resource data fusion according to claim 1, wherein the extreme gradient boosting tree prediction sub-model is trained by using temperature, humidity, solar zenith angle and irradiance data as input data, so as to establish a mapping relationship between the meteorological data and the photovoltaic power.

6. The hybrid photovoltaic power prediction method based on multi-resource data fusion according to claim 1, wherein the step of classifying weather types according to a cloud cover on the day to be predicted, and determining prediction weights of the prediction sub-models specifically comprises:
dividing the weather types into sunny, cloudy and overcast situations according to meteorological conditions, and dividing sample sets into a sunny set, a cloudy set and an overcast set; and
for the different sample sets, obtaining optimal weights of the sub-models by using a particle swarm optimization (PSO) algorithm, specifically comprising: first initializing weight particles of the three sub-models, evaluating the particles to obtain global optimality, if an accuracy condition is satisfied, continuously updating positions and velocities of the particles until an optimal result is obtained, and finally obtaining weights corresponding to respective results of the three sub-models.

7. The hybrid photovoltaic power prediction method based on multi-resource data fusion according to claim 6, wherein the weather types are classified according to the cloud cover, if a cloud cover is less than or equal to a % on the day, the day is determined to be sunny; if the cloud cover is greater than a % and less than or equal to b % on the day, the day is determined to be cloudy; and if the cloud cover is greater than b % on the day, the day is determined to be overcast, wherein both a and b are set values.

8. A hybrid photovoltaic power prediction system based on multi-resource data fusion, comprising:
a data acquisition module configured to acquire historical power sequence data and external meteorological data on a day to be predicted;
a power prediction module configured to input the data into a trained convolutional neural network prediction sub-model, long short-term memory network prediction sub-model and extreme gradient boosting tree prediction sub-model to predict photovoltaic power;
a prediction weight module configured to classify weather types according to a cloud cover on the day to be predicted, and determine prediction weights of the prediction sub-models; and
a data fusion module configured to fuse prediction results of the prediction sub-models on the basis of the weights to obtain a final prediction result of the photovoltaic power.

9. A terminal device, comprising a processor and a memory, wherein the processor is configured to execute an instruction, the memory is configured to store a plurality of instructions, and the instructions are loaded by the processor to perform the hybrid photovoltaic power prediction method based on multi-source data fusion according to claim 1.

10. The terminal device according to claim 9, wherein a correlation between each influence factor and the photovoltaic power is calculated by using a Pearson correlation coefficient, and the historical power sequence data as well as temperature, humidity and satellite image data are determined as input data of a prediction model.

11. The terminal device according to claim 9, wherein the convolutional neural network prediction sub-model is trained by using the satellite image data as input data, so as to determine the influence of cloud shading factors on photovoltaic power generation.

12. The terminal device according to claim 9, wherein the long short-term memory network prediction sub-model is trained by using the historical power sequence data as the input data, so as to train a mapping relationship between the historical power sequence data and the photovoltaic power at time t.

13. The terminal device according to claim 9, wherein the extreme gradient boosting tree prediction sub-model is trained by using temperature, humidity, solar zenith angle and irradiance data as input data, so as to establish a mapping relationship between the meteorological data and the photovoltaic power.

14. The terminal device according to claim 9, wherein the step of classifying weather types according to a cloud cover on the day to be predicted, and determining prediction weights of the prediction sub-models specifically comprises:
dividing the weather types into sunny, cloudy and overcast situations according to meteorological conditions, and dividing sample sets into a sunny set, a cloudy set and an overcast set; and
for the different sample sets, obtaining optimal weights of the sub-models by using a particle swarm optimization (PSO) algorithm, specifically comprising: first initializing weight particles of the three sub-models, evaluating the particles to obtain global optimality, if an accuracy condition is satisfied, continuously updating positions and velocities of the particles until an optimal result is obtained, and finally obtaining weights corresponding to respective results of the three sub-models.

15. The terminal device according to claim 14, wherein the weather types are classified according to the cloud cover, if a cloud cover is less than or equal to a % on the day, the day is determined to be sunny; if the cloud cover is greater than a % and less than or equal to b % on the day, the day is determined to be cloudy; and if the cloud cover is greater than b % on the day, the day is determined to be overcast, wherein both a and b are set values.
